(19) United States
(12) Patent Application Publication
(10) Pub. No.: US 2014/0164149 A1
(43) Pub. Date: Jun. 12, 2014

(54) Computerized Product Marketing and Promotional Method and System Using Two-Dimensional Code

(71) Applicants: Danny Ray Huff, Louisa, KY (US); Kimberly Sue Huff, Louisa, KY (US)

(72) Inventors: Danny Ray Huff, Louisa, KY (US); Kimberly Sue Huff, Louisa, KY (US)

(21) Appl. No.: 14/099,861

(22) Filed: Dec. 6, 2013

Related U.S. Application Data
(60) Provisional application No. 61/734,819, filed on Dec. 7, 2012.
(60) Provisional application No. 61/836,201, filed on Jun. 18, 2013.

(51) Int. Cl. G06Q 30/02

(52) U.S. Cl. CPC G06Q 30/0277
USPC 705/14.73

(57) ABSTRACT

A method and system for using two-dimensional code is provided which allows consumers to go online to review and order products and services promoted or sold by individuals or entities in the entertainment and performing arts industries. A product promoter/seller creates a personalized web page/website through a website administrator, then uploads products and information onto the personalized web page/website that the promoter/seller wishes to make available to consumers. Through the website administrator, the product promoter/seller orders a desired number of items which are imprinted with a password and an optically-visible two-dimensional code unique to the promoter/seller. A consumer scans the two-dimensional code with an Internet-enabled device having scanning applications, then enters password into a designated field on a display screen of the scanning device. Consumer may download products and information from a single file within the promoter/seller's website or web page.

### CROSS REFERENCE TO RELATED APPLICATIONS

This application is a utility application which claims priority to U.S. Provisional Application 61/734,819, filed on Dec. 7, 2012; and, U.S. Provisional Application 61/836,201 filed on Jun. 18, 2013. The entire disclosures contained in U.S. Provisional Application 61/734,819 and U.S. Provisional Application 61/836,201, including the attachments thereto, are incorporated herein by reference.

### FIELD OF THE INVENTION

The present application generally relates to a method and system of using an optically-readable code. More particularly, the present application relates to a computerized method and system of product marketing and promotion through the utilization of optically-readable two-dimensional code linked to internet or Universal Resource Locator (URL).

### BACKGROUND OF THE INVENTION

Over the years, significant change has been seen with the means by which such things as recorded music, art, and literature has been transferred. Music was recorded and transferred by vinyl albums for many years, until the vinyl record (album) medium was essentially made obsolete by cassette tapes and, more recently, by compact discs (CDs). Even more recently, recorded music has increasingly been sold and transferred by direct electronic transfer onto computers and portable hand-held music devices such as I-PODS and the like. Presently, a sizable portion of the recorded music sales in the United States and throughout the world occurs by direct electronic transfer.

A substantial portion of the revenue generated by recording and performing artists occurs through live performances and concert tours. Along with ticket sales revenues, the sale of albums, cassettes and compact discs (CDs) has traditionally been an important means for a touring musical artist to generate revenue. Typically, the CDs sold at live shows are first purchased by the artist from the record company at a discounted rate, and then sold at the concert venue at full retail price, so that the artist can make a sufficient profit on the CDs.

In addition to generating revenue through ticket sales and CD sales at shows and concerts, many artists are able to promote their products and/or generate considerable revenue during live shows through the sale or dispensing of such things as promotional materials, videos, photos, fanbooks, and autographed merchandise. Given that an artist may have just completed a performance which was well-received by the audience, many audience members may be motivated by the live performance to acquire, at the site of the performance, the performers' promotional materials, music, and other merchandise.

As recorded music sales are increasingly accomplished electronically, the artist is frequently left with no means to generate sufficient revenue through the sale of recorded music at the concert site. If a consumer enjoys an artist's show, the consumer may choose to purchase music electronically by using an I-phone or the like. However, this involves a direct sale between the music publisher and the consumer, leaving the recording artist out of the direct transaction. Furthermore, many consumers have moved away from the purchase of CDs and CD players, thus depriving the recording artist of a significant revenue-generating means. As such, a need exists for enabling recording artists to maintain their ability to continue generating revenues through the sale of recorded music, and to do so at a time when a consumer may be particularly motivated to make a purchase, such as at live shows.

The electronic transfer and downloading of purchased music is often accomplished through the on-line sale of music by companies such as I-Tunes. When such a transfer occurs, the purchaser typically uses a credit card or the like to complete an on-line electronic purchase from the seller. A method for purchasing online music which does not require the use of credit card information would make such transactions easier, would address consumer concerns regarding identity theft, and would thus result in an increase in the number of such transactions.

Many systems for making online purchases require the purchaser to undergo an online registration process and remember login information, which generally discourages the purchaser from using of such a system. Thus, a need also exists for a simpler and more convenient method for allowing purchasers to obtain information online and make retail transactions with minimum effort.

Bar codes have been and continue to be used for such business purposes as retail transactions, inventory management, consumer advertising and packaging, information storage, and various other uses. For some purposes, the use of the one-dimensional bar code is increasingly giving way to the use of two-dimensional code, which is capable of storing a larger amount of information in a smaller area relative to the one-dimensional bar code.

An item displaying a two-dimensional code may be provided as part of the consumer's admission ticket purchase, such as, for example, where the two-dimensional image appears on the ticket itself. This would allow consumers to make purchase transactions without the need to wait in line at the show or concert venue. Additionally, such a method would obviate the need for the artist to undertake the relatively cumbersome task of arranging transportation of CDs and various other items of merchandise to each concert site. Alternatively, the transportation of so-called “scan cards” or “download cards” to be sold at concert venues would also be a more manageable option to the transporting of large amounts of CDs and other merchandise to concert sites, and, to a significant extent, would also reduce the time that concert-goers would spend waiting in lines for purchases.

### SUMMARY OF EMBODIMENTS OF THE INVENTION

For purposes of explanation, the terms “user”, “users”, and “user's” referred to in the descriptions of various embodiments herein, are intended to generally refer to someone who uses an item displaying two-dimensional code for any of its uses, including accessing an artist's website in order to purchase merchandise and/or to review or obtain information uploaded onto the artist's web page or website; and, who uses an Internet-enabled device with scanning application to scan optically-visible two-dimensional code, to engage in such transactions or activities. “User”, “users”, or “user's” may be private individuals, but may alternatively be public or private entities.

The terms “artist”, “artists”, and “artist's” are generally used herein to refer to individuals, groups of individuals, or entities in the entertainment industry, who offer information to the public to promote their products, and/or who seek to generate revenue through sale of the products of their skill, creativeness, or artistic expression. More specifically, the terms “artist”, “artists”, and “artist's” are typically used herein to refer to musicians or musical groups. However, in other embodiments of the present application, the terms “artist”, “artists”, and “artist's” may also include other types of entertainers, along with writers/authors, lawyers, medical professionals, mechanics, or any other persons or entities who generate revenue through their craft, vocation, or business.

In an embodiment of the present method and system, an artist creates a web page/website account by registering with a website administrator. Registration may include providing information requested by the administrator. Such requested information may include, but would not necessarily be limited to, the artist's name, e-mail address and/or other contact information, desired account password, etc.

In an embodiment of the present method and system, a personalized hyperlink is also created for the artist, using a Universal Resource Locator (URL) and a two-dimensional code. Use of a personalized hyperlink or URL is taught by U.S. Pat. No. 8,069,115 for “METHOD AND SYSTEM TO PROCESS PAYMENT”, issued to Douglas Schoenberg on Nov. 29, 2011 (incorporated herein by reference). In some embodiments, the two-dimensional code used is the Quick Response (QR) code, developed by Nippondenso Company, Ltd., and which is taught in U.S. Pat. No. 5,726,435, issued on Mar. 10, 1998 (incorporated herein by reference).

After the artist's account is created, the artist may then access online tools provided by the website administrator which may enable the artist to create and customize his or her personal web page/website, and to upload any products or images that the artist wishes to sell or display. Such products or images could include, but would not necessarily be limited to, MP3s, JPGs, photo galleries, videos, music, and concert information.

In some embodiments, the website administrator creates a QR code that is unique to the artist who has registered with the website. In an embodiment of the present method and system, the unique two-dimensional code is a QR code which can combine with such modern technologies as smart phones and a wireless network to provide a plentiful assortment of consumer uses. The QR code allows users of smart phones (or other computing devices with optical scanner application) to scan the code and access data that is typically hosted by bar codes, and/or to access specific Internet URLs that can host a broader array of data which could include, but would not be limited to, promotional information, image galleries, digital video and audio content, testimonials, social media sites, and information for purchase of concert tickets, music, and wearing apparel.

The artist may ask the website administrator to requisition a desired quantity of items, imprinted with the artist's unique QR Code, to be delivered to the artist. Such items may include, but need not be limited to, promotional cards, Internet download cards, hang-tag cards, product or service gift cards, download cards, or other items with surfaces capable of visibly displaying imprinted QR Code.

In some of the many embodiments of the present method and system, said items may be purchased products. In some of the embodiments, said items may be items provided separately from a purchased item, as a gratuity or gift with purchase.

In some of the many embodiments of the present method and system, the items on which two-dimensional code is visibly displayed may include, but would not be limited to, products, product samples, containers, packages, or other items.

In some embodiments, the item which displays two-dimensional code further comprises a removable surface which could include, but would not be limited to, a scratch-off surface or peel-off surface which, upon removal, reveals the image of a password that can be entered after the two-dimensional code is scanned, to provide user access to an assortment of data from the artist's web page or website, including, but not limited to, promotional and product purchase information.

In one of the many embodiments, a password is a unique sixteen-digit alphanumeric password, randomly generated by the administrator of a website with which the artist has registered. In some of the embodiments, a password may comprise characters other than numbers or letters. In some of the embodiments, a password may comprise characters other than numbers or letters, alone or in any combination with numbers and/or letters. In some of the embodiments, a password may comprise at or between one to sixteen characters, or more than sixteen characters. In some embodiments, a password may be used no more than one time. In some embodiments, a password may be used more than one time. In some embodiments, a password is displayed on a separate item from an item which has two-dimensional code.

In one of the many embodiments, an item imprinted with images of two-dimensional code and password is sold in any retail environment, including but not limited to department stores, supermarkets, gift stores, and at concert or show venues.

In one of the many embodiments of the present method and system, a user who has purchased an item imprinted with a password and with the artist's unique QR code may scan two-dimensional code into the user's mobile phone device or other internet-enabled device having optical scanner application, such as by using a camera on two-dimensional code image in conjunction with special software—as is well understood in the mobile device and software arts, and thus need not be described in detail herein. The form server receives the two-dimensional code and retrieves the artist's web page/website. The user can then enter a password to access information that has been uploaded onto artist's web page/website.

In some embodiments, the optical scanner application with which the user scans the artist's unique QR code is a dedicated application that is downloaded onto the user's I-Phone or other internet-enabled device. The form server retrieves a screen in which a password may be entered to allow the user to download products, merchandise, and services previously uploaded by the artist onto the artist's web page/website. In some embodiments, the user may access all products, merchandise, and services from a single file in the artist's web page/website, such as, but not limited to, the artist's playlist. In some embodiments, the artist's products, merchandise, services, etc. may be downloaded into the optical scanner application itself.

In some embodiments, the website administrator uses an application programming interface to write applications that provide various services to allow users to view and make purchase selections from products and/or services uploaded by the artist onto his or her website, such as displaying content from Facebook®, Twitter®, the artist's playlist, etc. Use of application programming interface is taught by U.S. Pat. No. 7,844,915 for “APPLICATION PROGRAMMING INTERFACES FOR SCROLLING OPERATIONS”, issued to Apple, Inc. on Nov. 30, 2010 (incorporated by reference).

Some embodiments of the present method and system are configured to allow more than one download. Some embodiments are programmed to allow for a predetermined number of downloads.

Some embodiments of the present method and system allow use of the item displaying two-dimensional code to access additional information and services, after the same item has previously been used to access information and services.

In some embodiments of the present method and system, the item displaying two-dimensional code can be used to obtain free or discounted merchandise or event admissions.

Some embodiments of the present method and system may be customized for a particular event, such as but not limited to, seat locations, event-related promotions, etc.

Some embodiments of the present method and system may be customized to the user, such as, but not limited to, allowing certain users to access additional goods, merchandise, promotional information, etc.

### BRIEF DESCRIPTION OF THE DRAWINGS

FIG. 1 is a website administrator's computer screen used by artist to create a web page/website.

FIG. 2 is a computer screen for uploading information onto artist's web page/website.

FIG. 3 is a computer screen for creation and customization of artist's web page/website.

FIG. 4 is a computer screen for artist to order items through website administrator.

FIG. 5 is an exemplary two-dimensional code.

FIG. 6 is a front view of an item of the sort which artist may order through a website administrator.

FIG. 7 is a back view of an item, imprinted with two-dimensional code and password image, of the sort which artist may order through website administrator.

FIG. 8 is an illustration of the scanning of two-dimensional code, using Internet-enabled device having scanning application.

FIG. 9 is an illustration of some of the many types of information which user may access by scanning of two-dimensional code and entering password.

### DESCRIPTION OF THE EMBODIMENTS

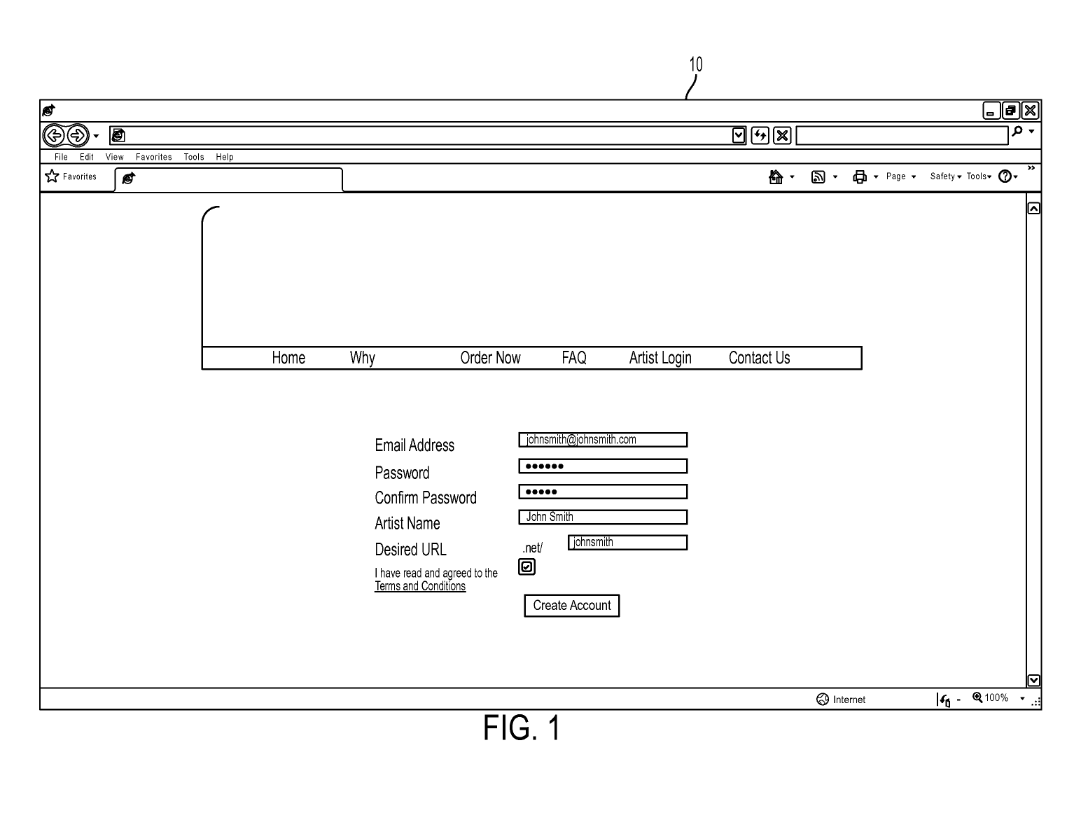

In one of the embodiments, the initial step for the present method and system is comprised of the creation of an account by the artist, through a web page/website administrator. In such embodiments, the account is instituted when the artist goes to screen 10, shown in FIG. 1, and enters information requested by the administrator. Such information could include, but would not necessarily be limited to, the artist's e-mail address, password, and desired URL.

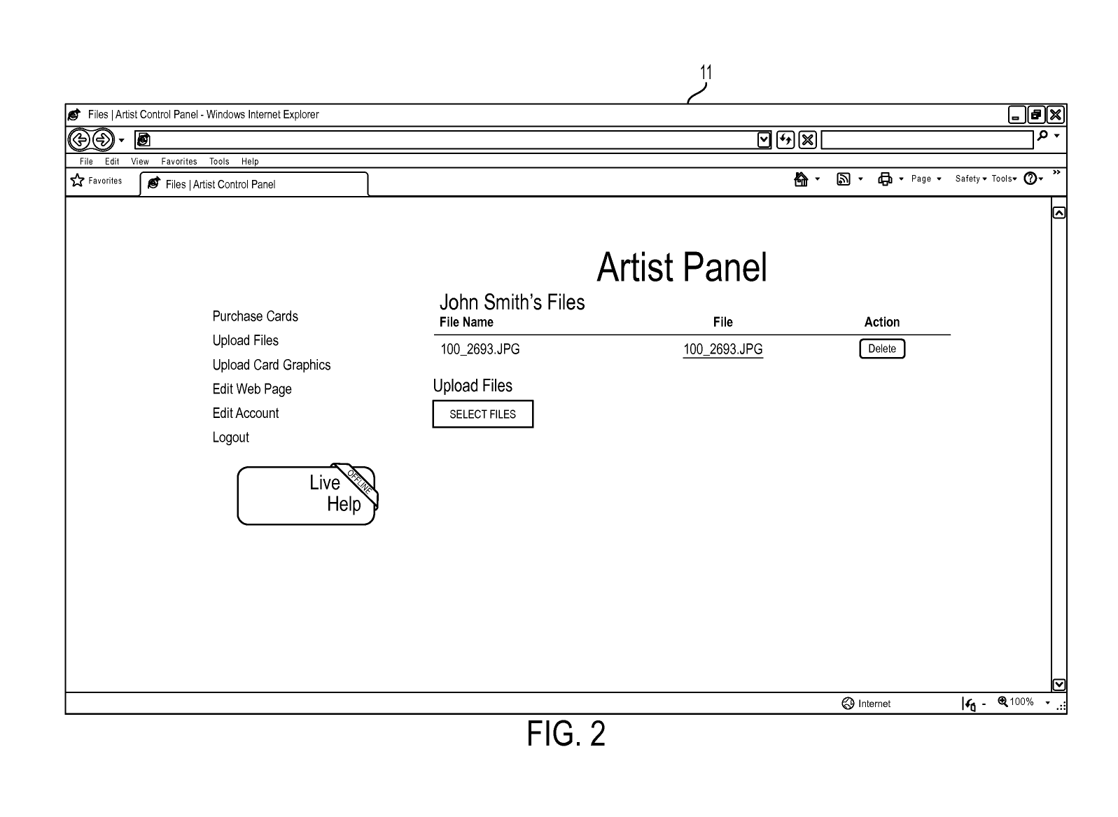

After the account is created, the artist may then access artist panel 11, shown in FIG. 2, which may enable the artist to upload any products or images that the artist wishes to sell or display. Such products or images could include, but would not necessarily be limited to, MP3s, JPGs, photo galleries, videos, music, and concert information.

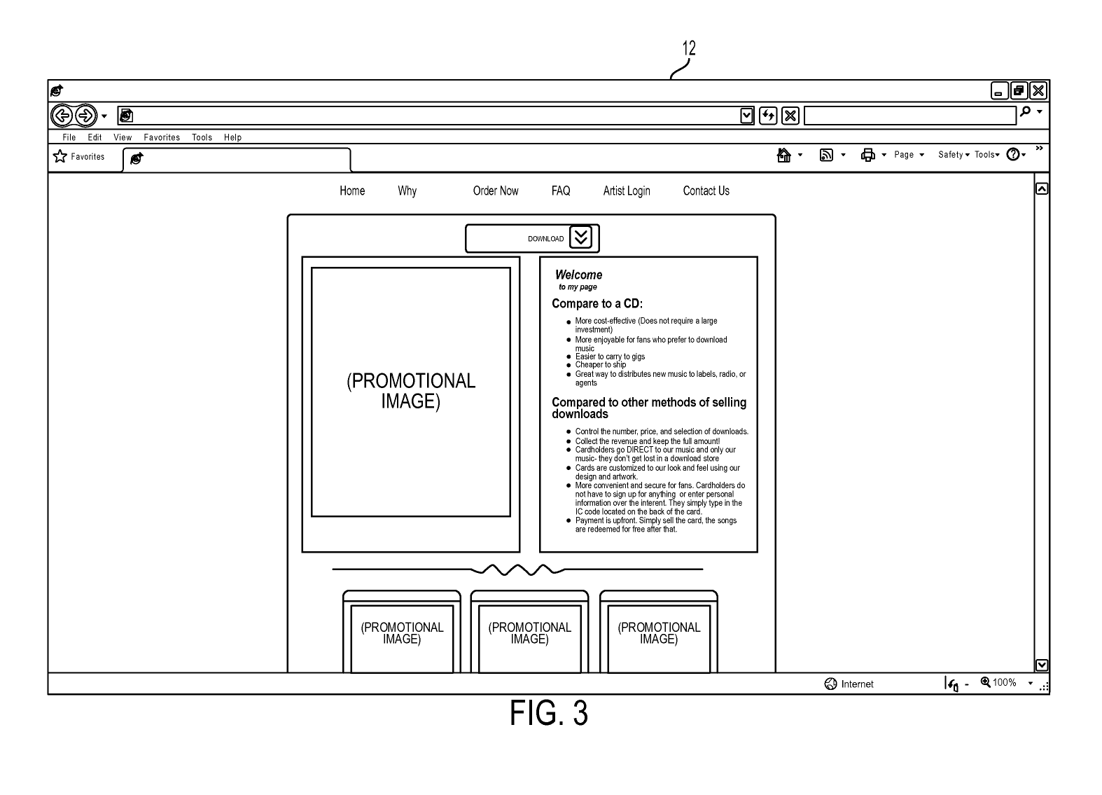

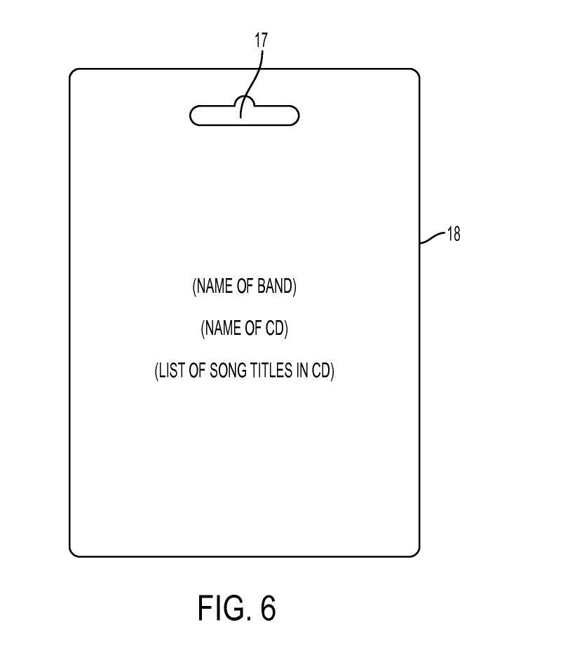

FIG. 3 shows customization screen 12 which may be used by the artist to create and customize his or her personal web page/website, and to provide such information to the web page/website administrator as the number of items 18 (see FIG. 6) displaying the QR code image password image that the artist wishes to sell to consumers at concerts, retail outlets, etc., as well as the price for which the artist wishes to sell items 18.

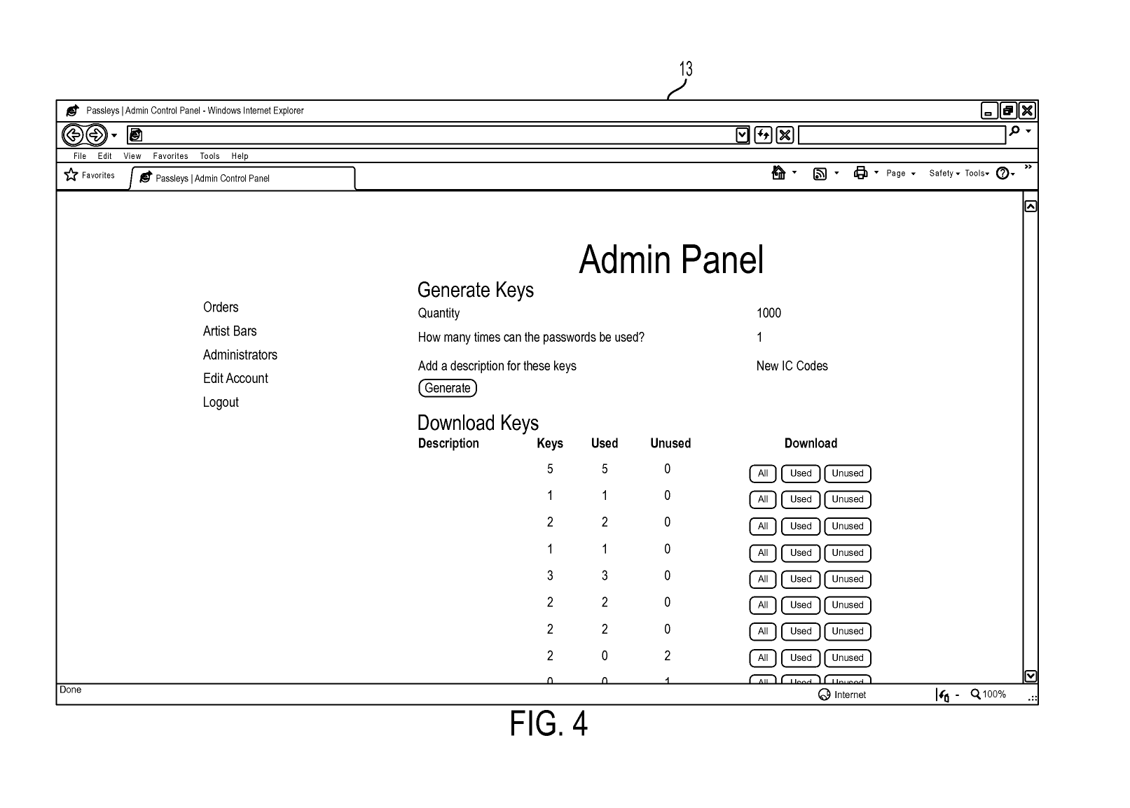

After the artist uploads the desired information onto his or her web page/website, the website administrator may then use administration panel 13, shown in FIG. 4, to receive and process the artist's request for ordered items 18. The website administrator may also input information regarding such matters as the number of times that each download card may be used, the password to be imprinted upon each individual download card, and the QR code to be created for the individual artist. The administrator then processes an order for the manufacture of the artist's download cards.

The website administrator may then distribute items 18 to the artist, who may then make items 18 available for purchase by the user at the artist's concert site or at retail establishments, etc.

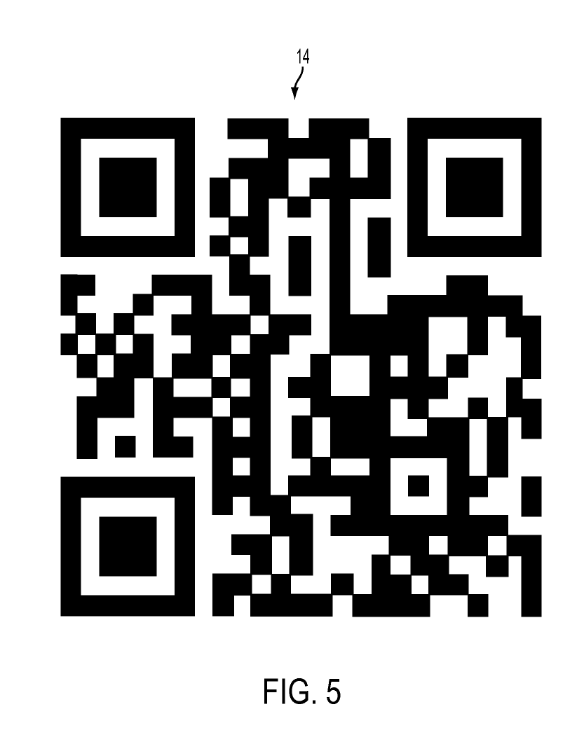

In one embodiment of the present method and system a user may download a dedicated/special optical scanner application onto an I-Phone or other internet-enabled device. Referring now to FIG. 5, an exemplary two-dimensional code 14 is shown. The user may scan two-dimensional code 14 into the dedicated optical scanner application. The present application is particularly useful with modern mobile devices such as mobile Smart Phones, I-Phones and the like. Some embodiments of the present application are not limited to being used with mobile phones or other mobile devices, but also contemplate utilization with any device that has internet-enabled optical scanning capabilities. Such devices would generally include devices having at least a processor, associated memory, and one or more input device, without limitation. Devices with appropriate applications could also include, but would not be limited to, desktop computers, laptop computers, minicomputers, and other devices.

FIG. 6 is a view of the front of item 18 which may display two-dimensional code 14 image, and/or a password 15 image. In the embodiment shown in FIG. 6, item 18 is an artist's promotional download card. In some of the many embodiments, item 18 may include, but would not be limited to, a product label, package, container, article of merchandise, or other thing on which scannable two-dimensional code 14 may be displayed.

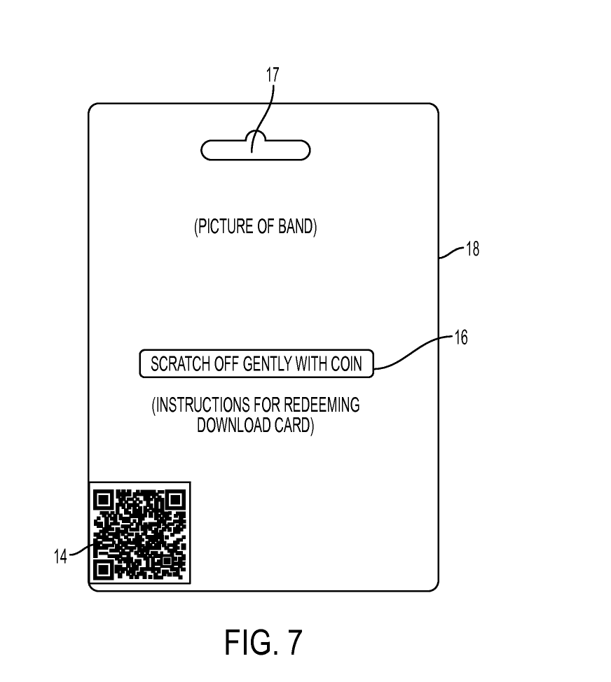

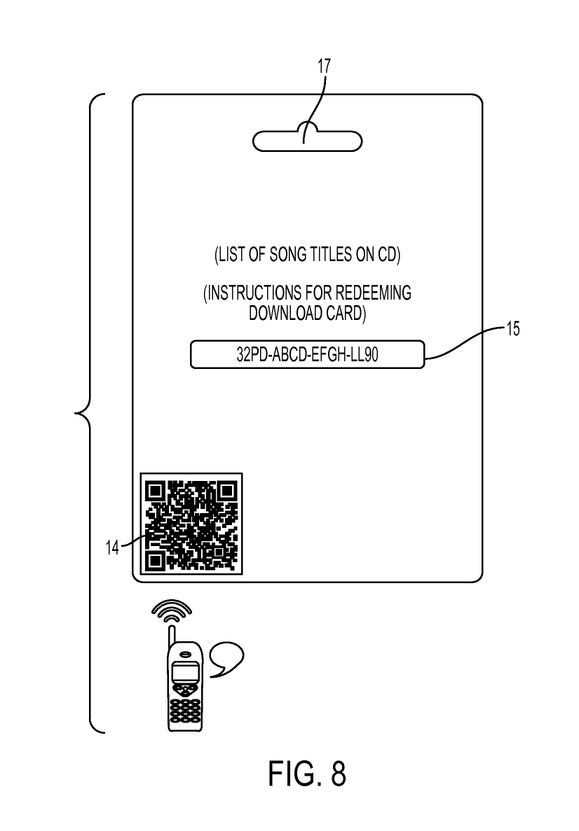

FIG. 7 is a view of back of item 18 shown in FIG. 6. In the embodiments shown in FIG. 7 and FIG. 8, two-dimensional code 14 and password 15 are both displayed on item 18. In some embodiments, image of two-dimensional code 14 and may be displayed on a separate item from an item displaying password 15. The embodiment in FIG. 7 has removable surface 16 which may be removed to reveal image of password 15 (see FIG. 8). Removable surface 16 may be peeled off, scratched off, erased, rubbed off, or otherwise easily removed to reveal password 15. In some embodiments, item 18 has no removable surface 16, so that password 15 is openly displayed.

FIG. 7 shows item 18 having hanging display aperture 17 which enables item 18 to hang for display at retail stores and other sales locations. In some of the embodiments, the image of two-dimensional code 14 and/or image of password 15 may be included on other types of cards or other items, with or without a hanging display aperture 17. Such items could include, but would not be limited to, gift cards, smart cards, wearing apparel, concert tickets, product packages, product labels, product containers, or other items on which said images may be imprinted.

FIG. 8 illustrates two-dimensional code 14 being scanned by an Internet-enabled device having a dedicated scanning application (not shown). In the embodiment in FIG. 8, the Internet-enabled device is a mobile phone. In some embodiments, two-dimensional code 14 may be scanned by any Internet-enabled device having a dedicated scanning application, which would include, but would not be limited to, such devices as desktop computers, minicomputers, and other such devices.

In one of the many embodiments, after a user has scanned two-dimensional code 14 with a dedicated scanning application, the user may enter password 15. In one of the many embodiments of the present method and system, password 15 is a sixteen-digit alphanumeric image. User may then download information and products that may be contained in a file located within an artist's web page/website, such as (but not limited to) an artist's playlist file. Information accessible to a user may be contained within one file, or may be contained within more than one file.

In an embodiment of the present device, the website administrator may use an application programming interface to write applications that enable users to select from the menus and icons on the artist's website to direct the function that the application is to perform.

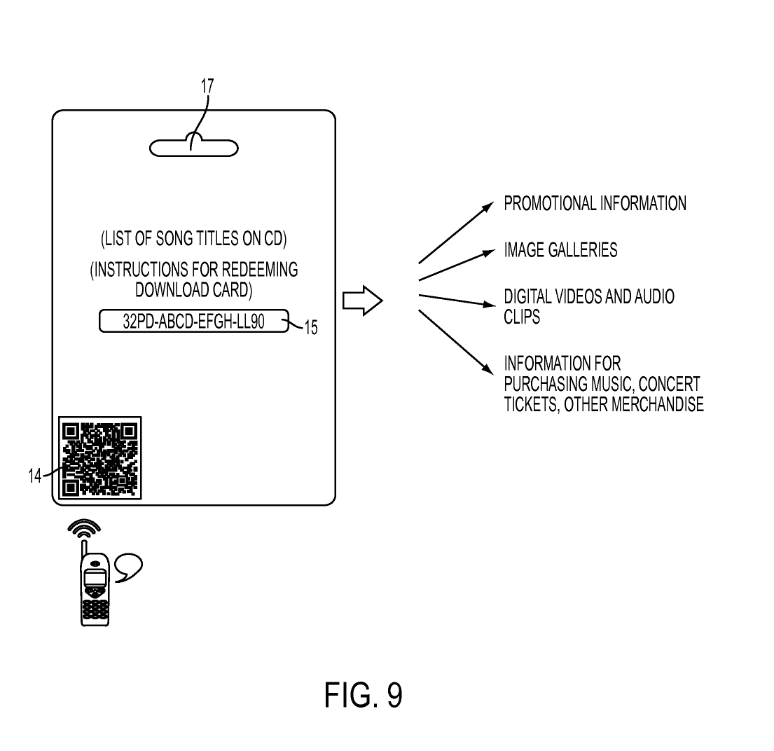

FIG. 9 shows a sample of data that a user may download from an artist's playlist or other file within the artist's web page/website. Such data may include, but would not be limited to, product promotions, merchandise purchasing information, testimonials, concert information, contest registration information, social media sites, picture galleries, and downloadable audio and video media.

In some embodiments, the user enters password 15 after using a dedicated optical scanner application to scan the artist's unique QR code, and is then able to download music files, videos, image displays, product information, etc. into the dedicated optical scanner application itself.

It is to be understood that the embodiments and claims herein are not limited in application to the details of construction and arrangement of the components set forth in the description and illustrated in the drawings. Rather, the description and the drawings provide examples of the embodiments envisioned, but the claims are not limited to any particular embodiment or a preferred embodiment disclosed and/or identified in the specification. The drawing figures are for illustrative purposes only, and merely provide practical examples of the invention disclosed herein. Therefore, the drawing figures should not be viewed as restricting the scope of the claims to what is depicted.

The embodiments and claims herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. A method of selling digital products over the Internet, comprising:
a web administrator providing a web site with an account creation page;
an artist using said account creation page to create an account;
following the creation of said account, said website allowing said artist to customize a webpage associated with said account, including the uploading of promotional images to said webpage;
said artist uploading digital products to said account;
said webpage presenting an online control panel and said artist requesting download cards from said web administrator through said control panel, said download cards comprising a scannable two dimensional optical code, said optical code communicating the address of said account on the Internet;
said web administrator providing said download cards to said artist;
said artist selling said download cards to a consumer for said consumer to access said account and download digital product by said artist.

2. The method of selling digital products of claim 1, further comprising:
a dedicated applet; wherein,
said consumer downloads said dedicated applet onto an Internet enabled mobile device; and,
said consumer scans said two dimensional optical code into said dedicated applet;
said two dimensional optical code directs said consumer to said account;
said two dimensional optical code is integrated into a custom application programming interface on said website;
said applet downloads, extracts, and properly stores said digital product based on the file type of said digital product.

3. The method of selling digital products of claim 2, wherein;
said applet displays image files and plays video and music files.

4. The method of selling digital products of claim 1, further comprising:
a keyboard code printed on said download card, said consumer entering said keyboard code upon arriving at said account to gain access to said account.

5. The method of selling digital products of claim 5, further comprising:
a removable covering on said download card over said keyboard code;
said consumer removing said removable covering to learn said keyboard code after said consumer has purchased said download card.

6. The method of selling digital products of claim 1, wherein:
the quantity of digital product that can be downloaded with each download card is limited.

7. The method of selling digital products of claim 1, wherein:
the quantity of digital product that can be downloaded with each download card is proportional in value to the cost of the download card.

8. The method of selling digital products of claim 1, wherein:
said download cards are sold at an event and provide access to digital product associated with that event.

9. A system for selling digital products over the Internet, comprising:
a server accessible over the Internet;
download cards comprising a scannable two dimensional optical code;
a web site hosted on said server, said web site comprising,
an account creation page for artists to create an account,
an upload page for account holders to upload promotional files and digital product,
an online control panel for account holders to request quantities of said download cards, said download cards saleable by said account holder to consumers;
a product download page accessible by scanning said optical code, said optical code communicating the address of said download page on the Internet.

10. The system for selling digital products over the Internet of claim 9, further comprising:
Internet enabled mobile devices capable of scanning said optical code;
a dedicated applet; and
a custom application programming interface at said web site;
wherein said web site further comprises a download page for said mobile devices to download said applet,
said applet allowing said mobile devices to scan said optical code to access said account,
said optical code being integrated into said custom application programming interface,
and said applet downloads, extracts, and properly stores said digital product based on the file type of said digital product.

11. The system for selling digital products of claim 10, wherein;
said applet displays image files and plays video and music files.
